(19) United States
(12) Patent Application Publication
(10) Pub. No.: US 2002/0117043 A1
(43) Pub. Date: Aug. 29, 2002

(54) Music tone identification method related with apparatus, notation, and instruments

(76) Inventor: Morris Leon Powley, Fonthill (CA)

Correspondence Address: MORRIS LEON POWLEY, 2 KEVIN DRIVE, FONTHILL, LU5 IE4, CA

(21) Appl. No.: 09/795,059

(22) Filed: Feb. 27, 2001

(51) Int. Cl. G09B 15/02

(52) U.S. Cl. 84/483.2

(57) ABSTRACT

A music tone identification method with related apparatus, notation, and instruments for past, present, and future musical notes. Each tone note body, character, picture, song word, song letter, or song syllable has unique identification comprised of color, shape, shading, and lines. A song comprising the tone notes has a colored bar at beginning and at end to indicate its key. Each of twelve musical tones within a level of scale is sung by a vocalized alphabetical tone name. Each rigid vibrator has its tone identified by means of a unique colored sticker or coating for sight ahd sound recognition. Each tone of a musical instrument may have its corresponding playing surface identified by an identification colored sticker decal or coating. Each tone of an electronic oscillator, generator, and tuner that is received or generated is identified by illuminated opto electronic display, sticker decal, or coating comprising the identification method. A process of operating a computer software graphics program comprises musical character notation by means of the unique identification method. Dance steps comprise position, color, and shading of footprints corresponding to the music tone identification method to identify tone notes for dance steps.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to a tone identification method of using colored characters for musical apparatus, notation, and instruments by means of the following: (1) symbols, pictures, words, syllables, and letters for tone identification of notation, (2) for vocal singing of alphabetic tone names in scales, (3) for tone identification of rigid vibrators, (4) for identifying tones by means of the playing surface of instruments, (5) for tone identification of an electronic oscillator, generator, and tuner by means of display, (6) for graphics software in comprising a computer program for musical character notation identification, and (7) colored footprints of dance steps that correspond to music tones.

The musical note is a black character placed on or between the lines of a staff to indicate the pitch and the relative duration of the tone to be produced by voice or instrument. Causes of confusion and difficulty of present music methods include:

1. Musical nomenclature includes the word semitone. It is better to avoid use of this word.

2. A note on a line or space can be three different sounds, natural, sharp, and flat.

3. The solfa method of singing does not teach the alphabetic tone names of music.

4. The musical note's black color makes it difficult to display a every tone, to relate notes to chords, and to teach young children.

5. Learning to sing, compose music, and play instruments requires the purchase of many books, which can be expensive, time consuming, and impractical.

6. Music books do not include notation for left handed stringed instruments and left handed instrument players.

7. Music books do not include simple notation showing how the tones of open strings of many instruments relate to each other.

8. There are no wind chimes to teach scales of different civilizations.

9. Rigid vibrators are not publicly color identified for tone level of scale.

10. Playing surfaces of instruments are not publicly color identified for tone level of scale.

11. Electronic oscillators, generators, and tuners that easily display unique identified tones of different levels of scale are not economically available to the public.

12. Colors have not been used to identify holes of harmonicas that relate to tones in different keys.

13. Computer software graphics programs do not comprise Morris Powley tone note scales with embodiments one to twelve for musical character notation identification.

14. Teaching methods of using colored footprints that correspond with music tones are not available.

Different types of musical notation have been invented. In the U.S. Pat. No. 122,096 (1871) by Fielding Wallace Acee assigns seven distinct colors to seven notes of the scale for singing by note. U.S. Pat. No. 1,383 (1839) is for writing music with two lines. U.S. Pat. No. 6,528 (1849) has seven natural tones one color and flats and sharps by another uniform color. U.S. Pat. No. 5,945,618 (1999) by Bennett Morgan uses eight colors for twelve notes, four of the notes using a combination of the eight colors.

### BRIEF SUMMARY OF THE INVENTION

This invention is a colorful identification method for every musical tone by means for the following:

1. Instead of needing a position on a staff where a note can have three different sounds of flat, sharp, or natural, new tone notes do not need a staff, flats, or sharps. They have independent identities and can stand alone to represent a tone.

2. Alphabetic tone names Aa, Bee, Cee, Dee, Ee, Faw, Gee, Hoh, Joh, Kay, Law, and Moh are used for singing the names of music tones.

3. Colored closed holes illustrate fingering of a pipe and reed for an identified tone.

4. Identification of the tones entering and exiting from an electronic oscillator, generator and tuner is by means of the new tone note scales or colored scale name on a display.

5. This invention is an easy and fun method to teach children notes, chords, singing, composition, and tuning an instrument. It can be used to teach spelling of words while learning to sing.

6. The method of using color in teaching good song composition and inventing musical scales is by means of the slider of drawing FIGS. 25 and 26, with its corresponding new tone note scale.

7. The illustration method of showing how the tones of open strings of many instruments relate to each other is by means of the new tone note scales.

8. The method of using identified wind chimes to teach scales of different civilizations and identify unique tones is by means of the new tone note scales.

9. The method of using color for tone identification of tones produced by harmonicas in different keys, and which holes to play, is by means of the new tone note scales.

10. The method of using unique tone identification stickers on children's fingers of both hands and associating them with corresponding playing surfaces of a keyboard or piano is by means of the new tone note scales.

11. The method of using notes that can be transposed and superimposed to all notation systems and scales of present and past history, with scales including diatonic, pentatonic, chromatic, Espla, and microtonal is by means of the new tone note scales.

12. The new tone notes can vary their number of vibrations per second to accounodate different composers.

13. Song words, syllables, and letters with shading and lines above or below to indicate tone or pitch and colored bars before and after indicating key of the song correspond to the new tone note scales.

15. You can represent any musical sound tone with a symbol, shape, bird head, animal head, human head, picture, word, syllable, or letter by using the new tone note scales.

16. The method of teaching persons to tune their stringed instruments is by means of the new tone note scales, scale names, identified tuner, and identified vibrators.

17. The method of teaching recognition of chords of music by sight and sound is by means of the new tone note scales.

18. The method of tone identification of a rigid vibrator by sight and sound is by means of the new tone note scales.

19. Colorful identification stickers of tone notes on the musical instrument's playing surface comprise the means for learning, teaching, and playing right and left handed instruments, and are simple to understand.

20. Tone identification sticker decals or coatings for teaching devices, charts, or boards for instruments or fingers comprise the new tone note scales and scale names.

21. The method that electronic oscillators, generators, and tuners display identified tones in a simple manner at a reasonable economic price to the general public is by means of the new tone note scales.

22. Computer software graphics programs comprise new tone note scales with embodiments one to twelve for musical character notation identification and are typically used in FIGS. 1 to 27.

23. The teaching method of using colored footprints for dance steps that correspond with identified tones is by means of the new tone note scales in FIGS. 1 to 12, 14F, and 27.

Reference Numerals In Drawings

None

### BRIEF DESCRIPTION OF THE SEVERAL VIEWS OF THE DRAWING

The file of this patent contains at least one drawing executed in color. Copies of this patent with color drawing(s) will be provided by the Patent and Trademanrk Office upon request and payment of the necessary fee. There are 27 pages of colored drawings.

FIG. 1 Preferred embodiment 1a for Morris Powley tone note scale of 168 tones for instruments, notation, singing, and footprints comprising an ellipse with one of twelve colors, shading, and lines above or below; and scale name located underneath each embodiment. 1/27

FIG. 2 Preferred embodiment 2a for Morris Powley tone note scale of 168 tones for instruments, notation, singing, and footprints comprising a circle with one of twelve colors, shading, and lines above or below; and scale name located underneath each embodiment. 2/27

FIG. 3 Preferred embodiment 3a or Morris Powley tone note scale of 168 tones for instruments, notation, singing, and footprints comprising an extrovert rectangle with one of twelve colors, shading, and lines above or below; and scale name located underneath each embodiment. 3/27

FIG. 4 Preferred embodiment 4a for Morris Powley tone note scale of 168 tones for instruments, notation, singing, and footprints comprising a triangle with one of twelve colors, shading, and lines above or below; and scale name located underneath each embodiment. 4/27

FIG. 5 Preferred embodiment 5a for Morris Powley tone note scale of 168 tones for instruments, notation, singing, and footprints comprising an introvert rectangle with one of twelve colors, shading, and lines above or below; and scale name located underneath each embodiment. 5/27

FIG. 6 Preferred embodiment 6a for Morris Powley tone note scale of 168 tones for instruments, notation, singing, and footprints comprising a diamond with one of twelve colors, shading, and lines above or below; and scale name located underneath each embodiment. 6/27

FIG. 7 Preferred embodiment 7 for Morris Powley tone note scale of 168 tones for notation and singing comprising an alphanumeric letter, syllable, or word with one of twelve colors, shading, and lines above or below; and with scale name located underneath each embodiment. 7/27

FIG. 8 Preferred embodiment 8a for Morris Powley tone note scale of 168 tones for instruments, notation, singing, and footprints comprising a bird head with one of twelve colors, shading, and lines above or below; and with scale name located underneath each embodiment. 8/27

FIG. 9 Preferred embodiment 9a for Morris Powley tone note scale of 168 tones for instruments, notation, singing, and footprints comprising a first animal head with one of twelve colors, shading, and lines above or below; and with scale name located underneath each embodiment. 9/27

FIG. 10 Preferred embodiment 10a for Morris Powley tone note scale of 168 tones for instruments, notation, singing, and footprints comprising a female human head with one of twelve colors, shading, and lines above or below; and with scale name located underneath each embodiment. 10/27

FIG. 11 Preferred embodiment 11a for Morris Powley tone note scale of 168 tones for instruments, notation, singing, and footprints comprising a male human head with one of twelve colors, shading, and lines above or below; and with scale name located underneath each embodiment. 11/27

FIG. 12 Preferred embodiment 12a for Morris Powley tone note scale of 168 tones for instruments, notation, singing, and footprints comprising a second animal head with one of twelve colors, shading, and lines above or below; and with scale name located underneath each embodiment. 12/27

FIG. 13 Typical embodiments 1a, 1b, 2a, 2b, 3a and 5a, 3b and 5b, 4a, 4b, 6a, 6b, 8a, 8b, 9a, 9b, 10a, 10b, 11a, 11b, 12a, and 12b of the Morris Powley tone note musical scale for notation, for playing surfaces of instruments, for singing, and for dancing. 13/27

FIG. 14 Method of singing and dancing by means of color, shading, and lines.

FIG. 14A. Twelve colors for dodecaphonic notes with their associated note names; C, K, D, L, E, F, M, G, H, A, J, and B.

FIG. 14B. Twelve colors for typical song words using embodiment 7; examples: Love, War, Silly, Lap, Ed, Maw, zoo, bud, hoe, ail, Joe, and Be.

FIG. 14C. Twelve colors for twelve alphabetic tone names: Cee, Kay, Dee, Law, Ee, Faw, Moh, Gee, Hoh, Aa, Joh, and Bee.

FIG. 14D. Typical example of song words using a black background, accent size, and duration space intervals, with light orange colored bars at the beginning and end of the song to indicate the key of C.

FIG. 14E. Typical example of song words using a white background, accent size, and duration space intervals, with taupe or light brown colored bars at the beginning and end of the song to indicate the key of A.

FIG. 14F. Twelve colors for footprints for dancing.

FIG. 15 Typical color for pipe and reed instrument notation is illustrated by a typical wind instrument with closed holes colored for tones in eighth and ninth scale levels in the keys of C and G. Note: When wind instruments are overblown, they may generate other tones. 15/27

FIG. 16 Typical lengths of rigid vibrators with unique identification attached or coated on the bodies. They may be hollow or solid, and may be metal, wood, plastic, or ceramic.16/27

FIG. 16A. Three dimensional view of typical rigid vibrators for the ninth and tenth levels of the dodecaphonic or twelve tone scale.

FIG. 16B. Typical rigid vibrator with optional holes interjected through for support.

FIG. 16C. Typical wind chimes with tone identification design attached or coated on. While they are constructed using typically four to six rigid vibrators, this example has five with their tones identified. The view is three dimensional. 17/27

FIG. 17 A contrast of names of the historical philosophical scale with its number of vibrations per second and its close relationship to Morris Powley tone note scale. However Morris Powley tone notes do not have a set number of vibrations per second, but rather will vary slightly depending on temperature, tuning of an instrument, composer, and the conductor of the orchestra and vocal group. 17/27

FIG. 18 Typical examples of instruments illustrating their playing surface and identification of their corresponding Morris Powley tone notes, on the following instruments:

FIG. 18A. Guitar

FIG. 18B. Bass guitar

FIG. 18C. Ukulele

FIG. 18D. Baritone ukulele

FIG. 18E. Ten hole harmonica in the key of C, breathing out

FIG. 18F. Flute

FIG. 18G. Keyboard or piano in a split view 18/27

FIG. 19 Typical sticker designs for instrument playing surfaces. 19/27

FIG. 19A. Bass guitar

FIG. 19B. Guitar

FIG. 19C. Keyboard or piano

FIG. 19D. Fingers

FIG. 19E. Five string banjo

FIG. 19F. Violin

FIG. 19G. Tenor banjo or viola

FIG. 19H. Mandolin

FIG. 19I. Uke

FIG. 20 A split view comprising a typical method of dividing a string into dodecaphonic tones. The example is fourth string of a tenor banjo. 20/27

FIG. 21 A split view comprising a typical method of color identification for relationships between tuning open strings on various instruments including the following: violin, mandolin, ukulele, baritone ukulele, lute, five string banjo, cello, viola, tenor banjo, guitar, bass guitar, and double bass. 20/27

FIG. 22 illustrates a method for instrument chord identification comprising typical identification stickers on fingerboards of stringed instruments.

FIG. 22A illustrates a method for finger placements and identification sticker locations on instrument playing surfaces of right handed stringed instruments by means of typical examples of chord illustrations in the keys of C or G7 for the following instruments: bass guitar, guitar, lute, mandolin, five string banjo, tenor banjo, and ukulele.

FIG. 22B illustrates a method for finger placements and identification sticker locations on instrument playing surfaces of left handed stringed instruments by means of typical examples of chord illustrations in the keys of D and A7 for the following instruments: bass guitar, guitar, lute, mandolin, five string banjo, tenor banjo, and ukulele.

FIG. 23 Typical electronic oscillator, generator, and tuner for identifying, importing, exporting, and displaying tones by means of using the Morris Powley tone note identification method and tone scale names. 22/27

FIG. 23A. Typical top view of component layout:

microphone sound pickup,

speaker,

electronic oscillator and integrated circuits,

variable frequency tuner and switch,

battery power supply,

automatic power down,

pushbuttons to operate,

external input output ports, and

illuminating opto electronic display panel.

FIG. 23B. Typical three dimensional view. The musician can adjust the frequency of any tone by means of the variable frequency tuner and switch, and thus compensate for any tone in any scale in past, present, or future history.

FIG. 24 Method for typical identification of twelve alphabetic tone names for singing by means of using the following names: Cee, Kay, Dee, Law, Ee, Faw, Moh, Gee, Hoh, Aa, Joh, and Bee. 23/27

FIG. 24A. The method of tone identification by means of this invention for typical mezzosoprano singing, using tonic solfa, alphabetic tone names, and scale names.

FIG. 24B. The method of tone identification by means of this invention for typical female and male alto singing using tone scale names, tonic solfa, and alphabetic tone names.

FIG. 24C. An illustration with white background comprising the typical means of tone identification for tenor singing using scale names, tonic solfa, and alphabet tone names. 24/27

FIG. 24D. An illustration with black background comprising the typical means of tone identification for tenor singing using scale names, tonic solfa, and alphabet tone names.

FIG. 25 Slider member 2, when printed on transparency film, forms viewing ports for keys of various scales including the following: Major, minor, Pentatonic Major, Pentatonic minor, Blues, Jazz minor, Harmonic minor, Diminished, Locrian, Phrygian, Dorian, Hungarian Gypsy, Mixolydian, Lydian, Skip a tone, Scottish Highland bagpipe, and Invent your own musical scale. The key of a song is the first viewing port on each line.

FIG. 26 Slider member 1, the moveable inside sliding member, comprises an embodiment la of Morris Powley tone notes combined with their scale name. 26/27

FIG. 27 Typical method for musical training using Morris Powley tone notes. The illustrations comprise typical structure of the new notation method with some embodiments intermingled with older methods. The example song is “Shave and a Haircut” in key of C. Typical identifying stickers are on some right and left handed stringed instruments. The dark color of the note stem and larger size indicates a strong accent. Embodiment 1a is used for violin. Embodiment 2a is used for mandolin. Embodiment 3a is used for banjo. Embodiment 4a is used for guitar. Beneath each note is the corresponding scale name, tonic solfa name, alphabetic note name, and song word. Musical notes are in the key of C′. The figure also comprises background and composition. Identifying tone note stickers are placed on fingers of both hands for playing the keyboard or piano. A tuned wind chime trains the ear for the tones in the song “Shave and a Haircut” in the key of C′. Colored footprints for dance steps correspond to the color and shading of the tune notes. Also shown are typical Morris tone notes with embodiments 1a and 1b.

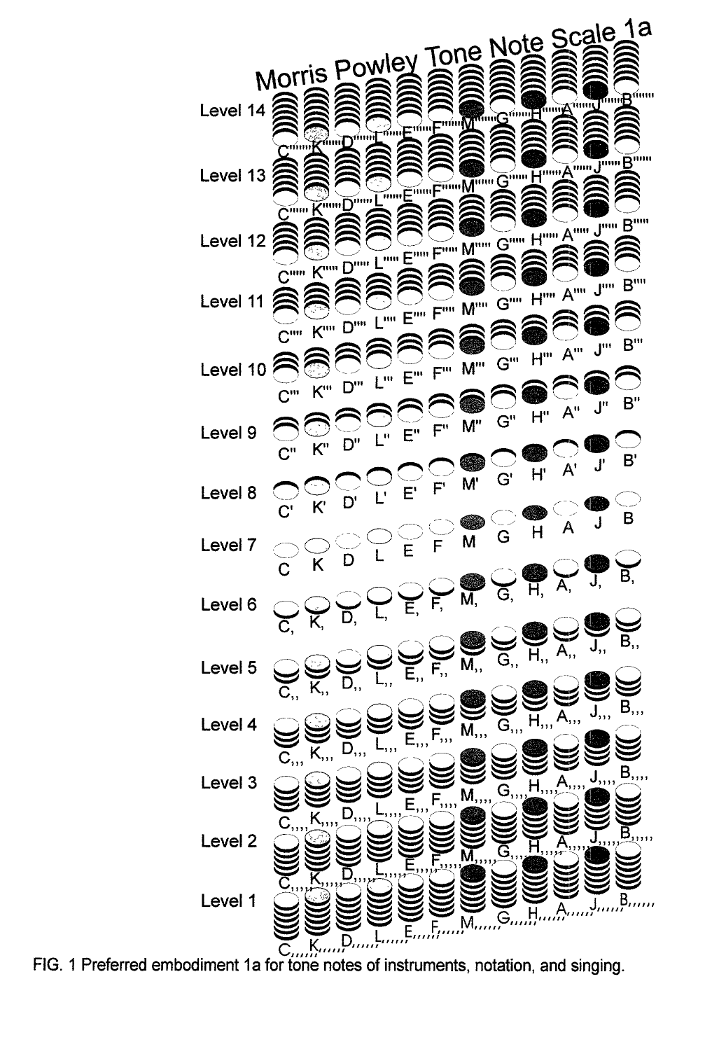

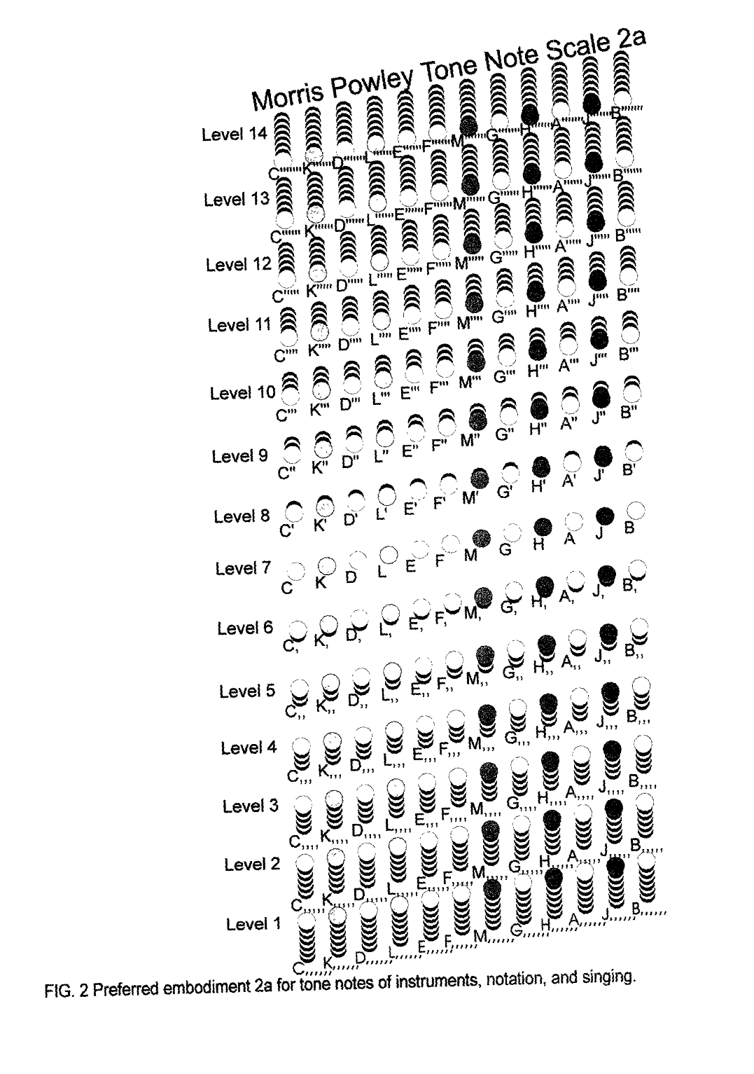

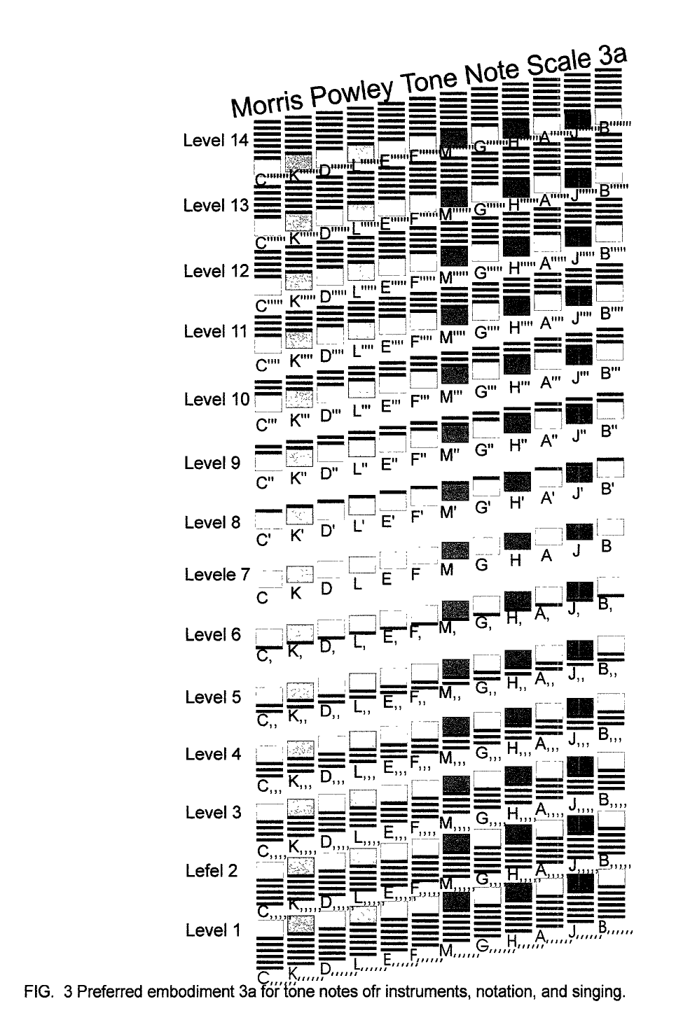

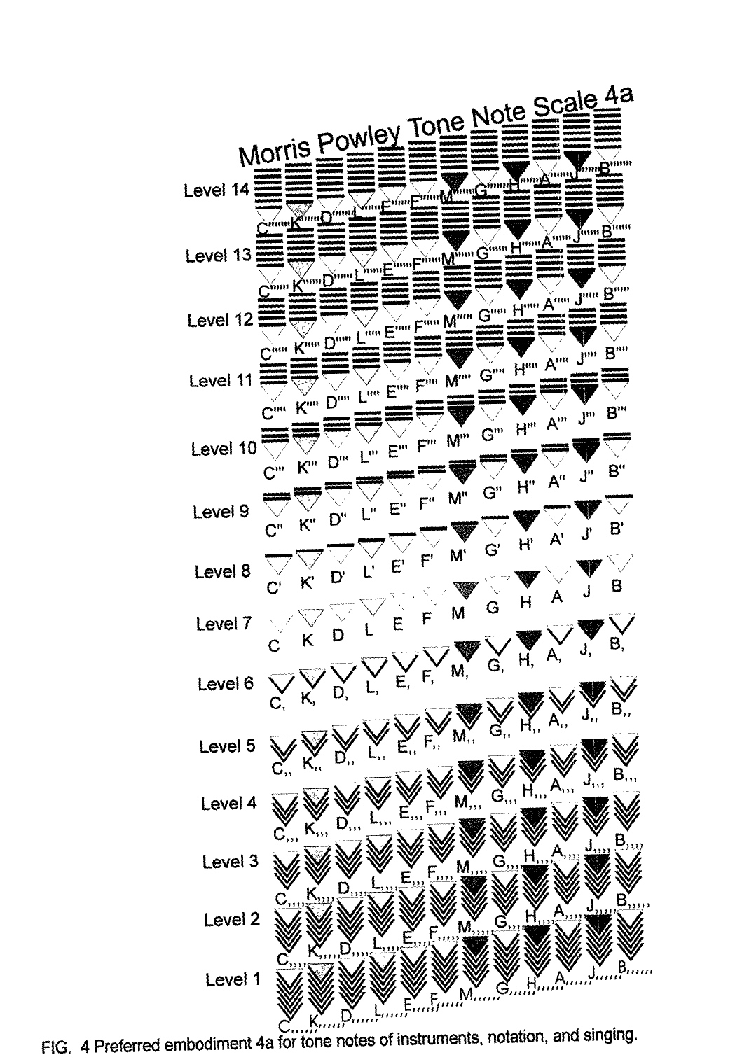

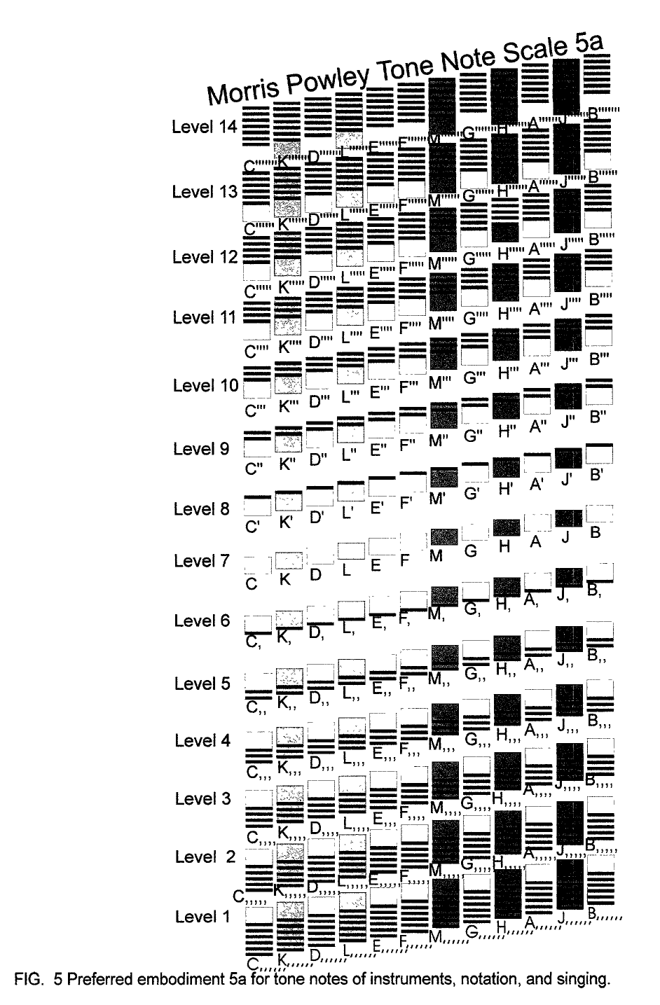

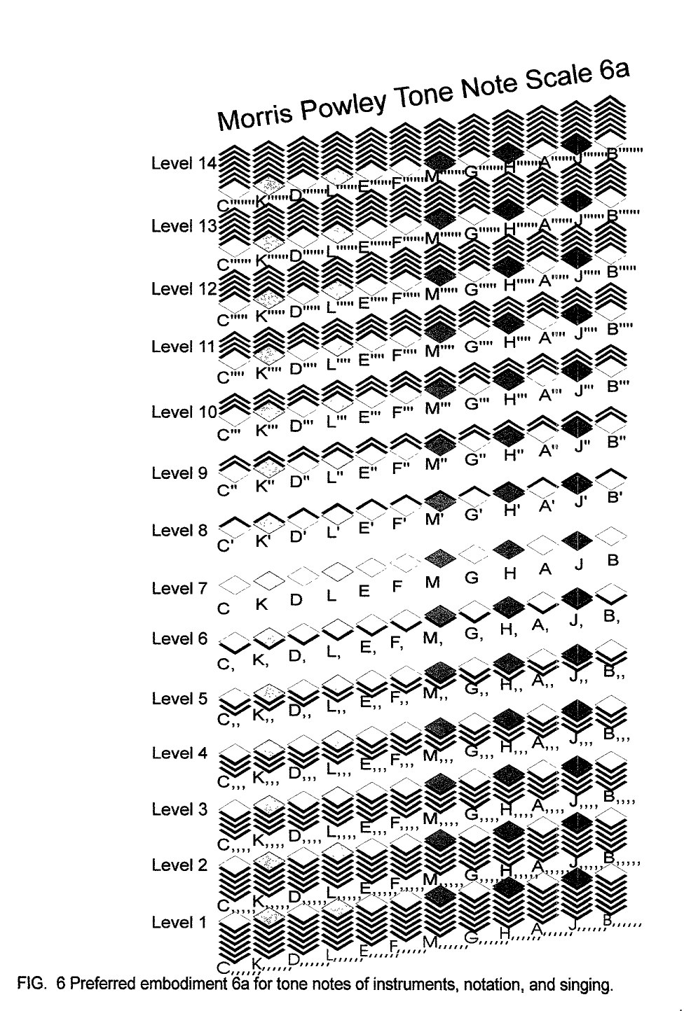

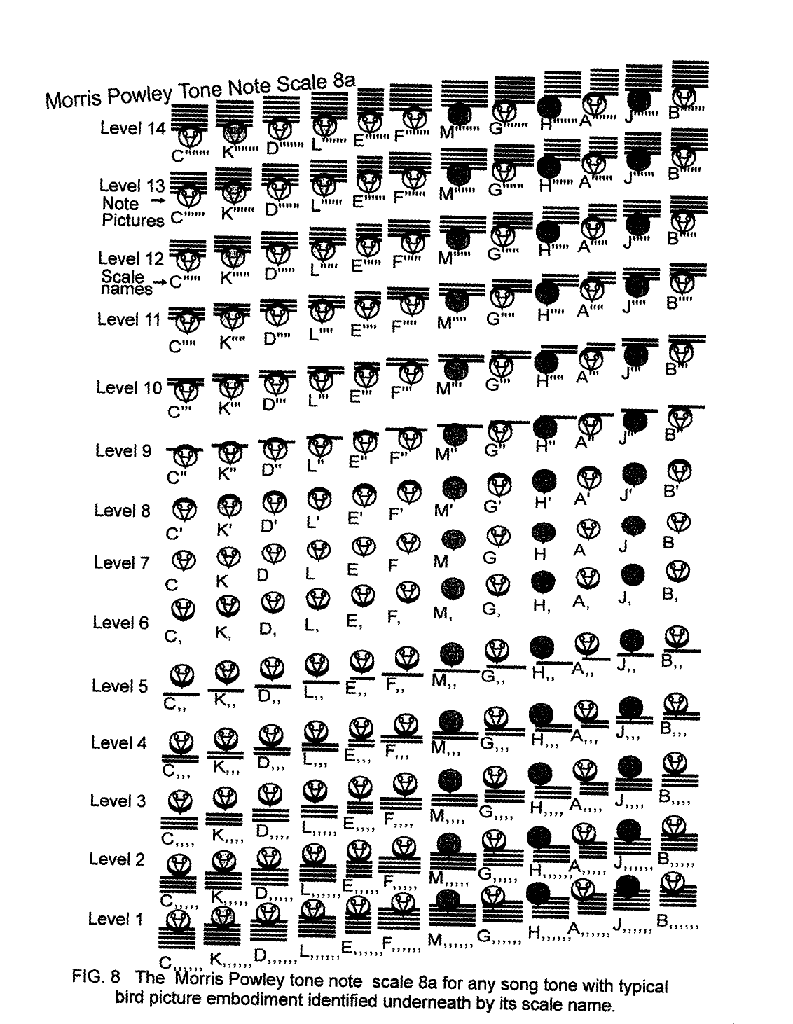

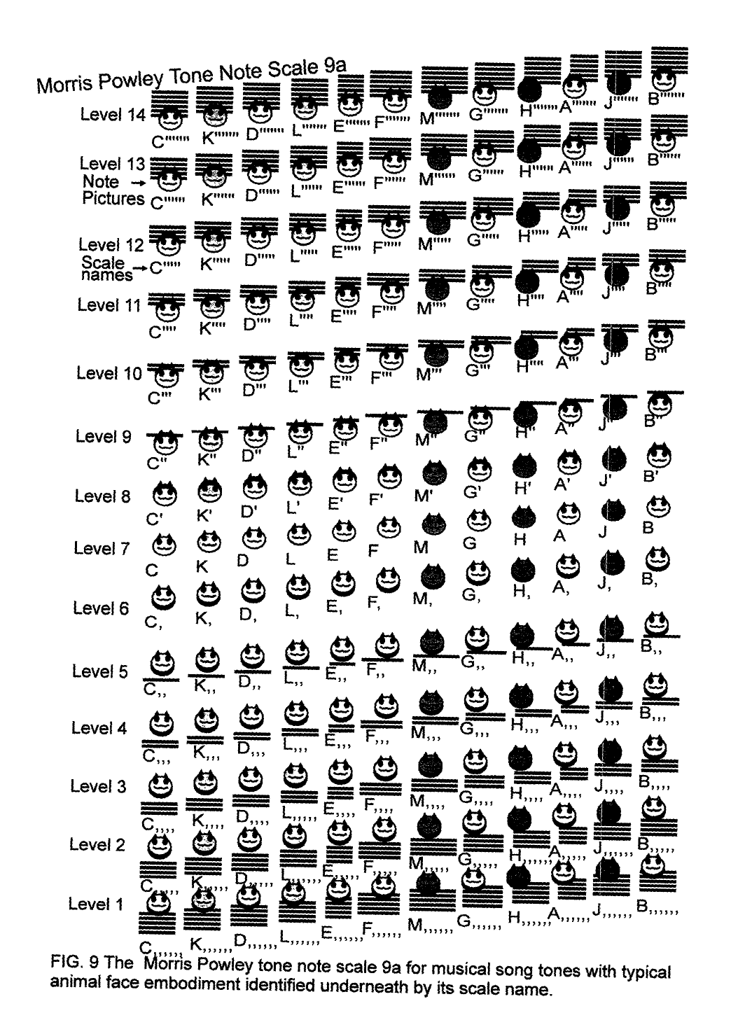

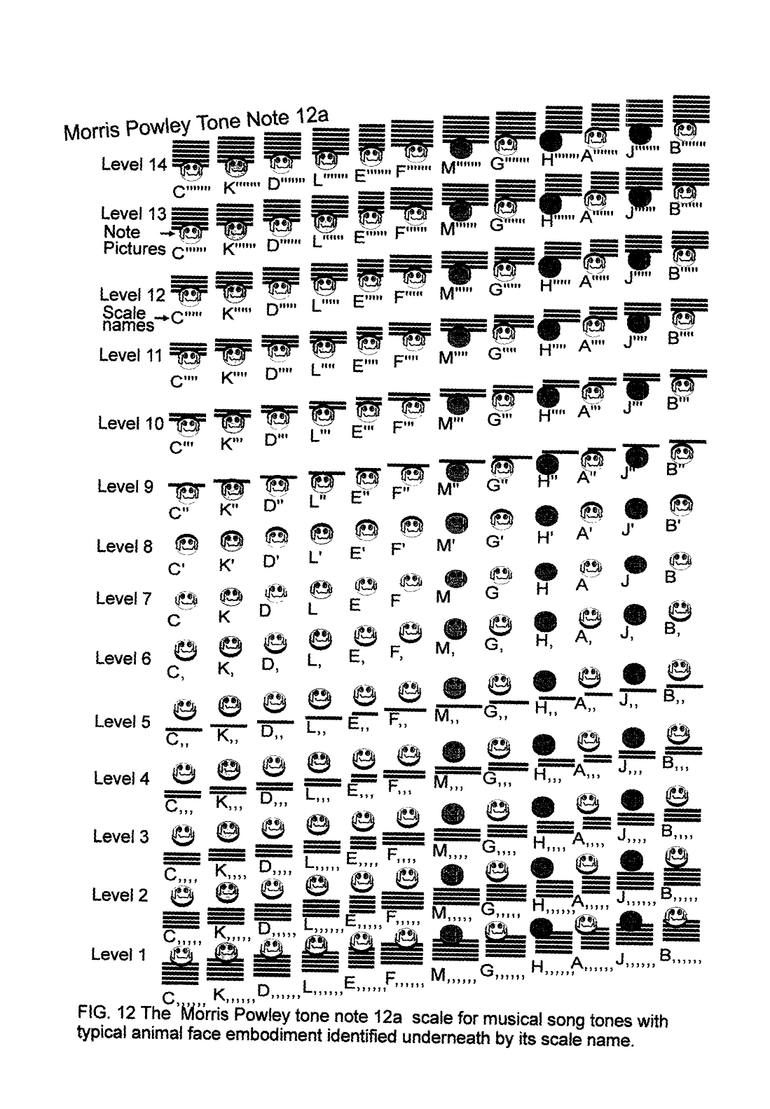

Computer software graphics programs do comprise Morris Powley tone note scales with embodiments one to twelve for musical character notation identification and are used in FIGS. 1 to 27,

### DETAILED DESCRIPTION OF THE INVENTION

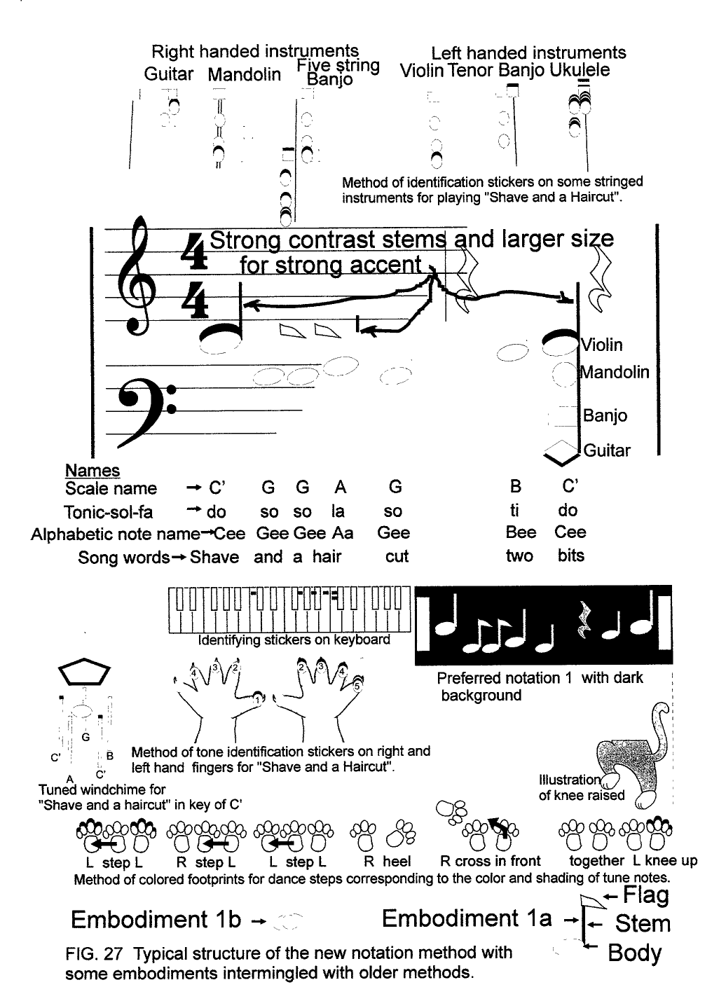

This unique identification method of tones is taught by means of songbook, and is used in combination with tone identification stickers, colored pens, an electronic tone oscillator or tuner, musical instruments, singing, and wind chires. Pens with colors of ink that correspond to tones in a scale are used for music composition. The identification stickers may be attached to, coated on, or integrated with fingers, tune sheets, fingerboard of musical instruments, teaching devices, charts or boards, pipes and reeds, rigid vibrators, strings, vibration detectors, electrical oscillators or generators, and computers. The songbook uses the identification method on instruments in exercises beginning with a few distinct notes, to more difficult songs that extend beyond one level of scale. Each practice and song may be illustrated in more than one key to accommodate different instruments and voices. FIG. 27 illustrates a typical teaching method that combines singing, right and left handed instruments, notation, dancing, stickers, composition, and tuning.

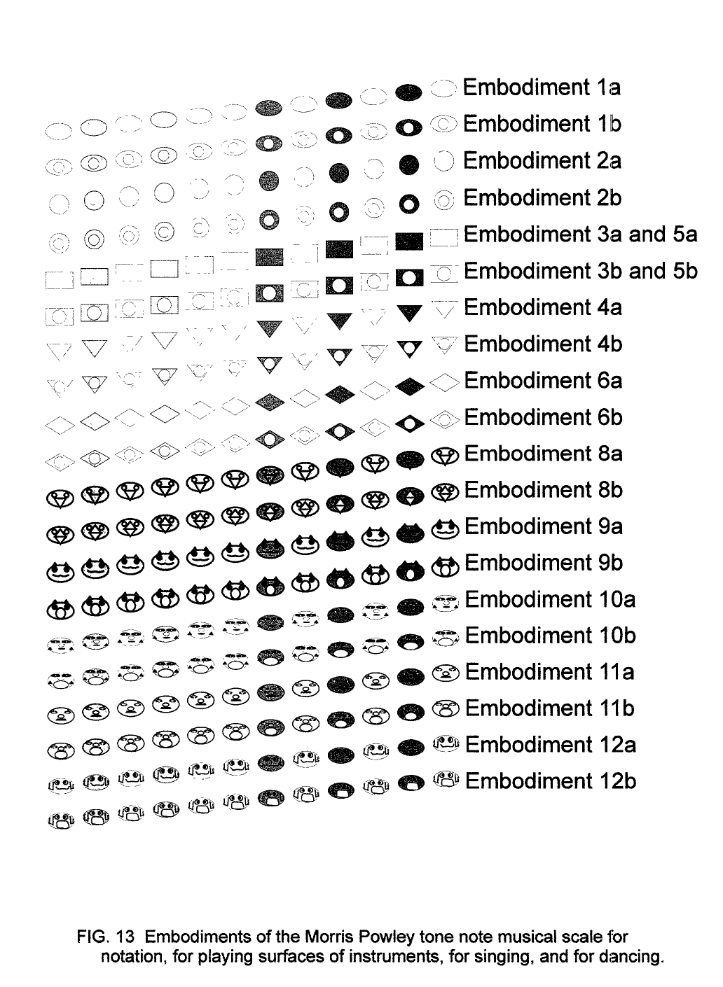

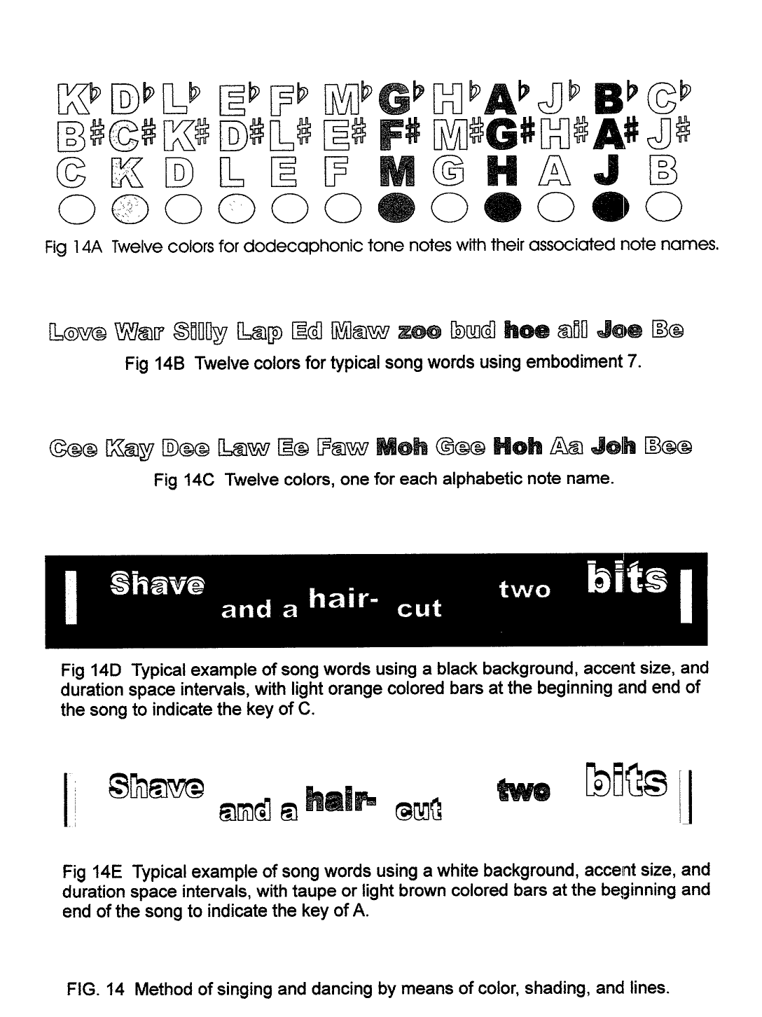

A musical tone note is a character of a tone, duration, and accent. Each tone note is assigned a unique color and shape character combination or body that differentiates it from all other 167 tones in all levels or units of a scale. It does not require a staff with lines and spaces, sharps, flats, naturals, treble clef, bass clef, or bar measures, but it may use them. Morris Powley tone notes do not need a staff, flats, or sharps, as they have independent identities and can stand alone to represent a tone. Morris Powley tone notes do not need measure bars to indicate accent, as their stem or size indicates accent. An identified tone note is comprised by a color or combination of colors as shown in FIGS. 1 to 13. It's duration may be comprised by body shape as shown in FIG. 13, or by space interval between centers of words as shown in FIG. 14. Its accent or stress may be comprised by color contrast of stem, or size of note body as shown by FIG. 27. There are twelve preferred embodiments of tone notes as shown by the Morris Powley tone note scales with one embodiment in each of FIGS. 1 to 12. The embodiments may be used at the discretion of the music composer to indicate which instrument or which voice is to be used.

Unique identification is used for one hundred and sixty eight tone notes in a scale comprised of fourteen levels, each level containing twelve distinct colored tone notes, as shown in each of FIGS. 1 to 12. The tone notes have twelve preferred embodiments for instruments, notation, singing, and footprints. The comprise a character with colors, shading, and lines above or below; and scale name located underneath each embodiment.

The notation method includes the following:

1. Use of the Morris Powley tone notes, transposed or superimposed, on diatonic, dodecaphonic, pentatonic, chromatic, Espla, or microtonal scales.

2. For the identification method by simple alphabetic letter of chromatic sharp notes and flat notes, the typical colors are as follows for each level of scale: C is light orange, K is dark orange, D is light yellow, L is dark green, E is light green, F is light blue, M is dark blue, G is light grape, H is dark grape, A is light brown or taupe, J is dark red, B is light red. This is illustrated in FIG. 14A for dodecaphonic tone notes, FIG. 14B for typical song words, FIG>14C for alphabetic note names, FIG. 14D for typical song words using a black background, and FIG.14E using a white background.

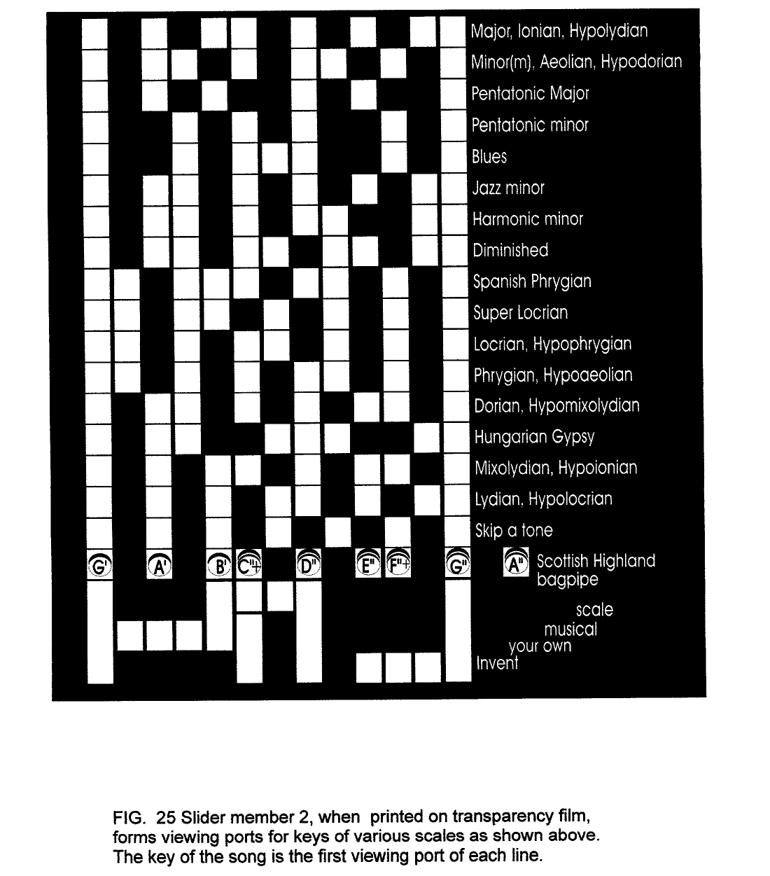

3. Notation for instruments of different pitch, such as the Scottish Highland bagpipe which have the note tones C″ and F″ slightly higher in tone may be accommodated by the composer using a symbol with the embodiment. For a typical example, see slider member 2 in FIG. 25 where a plus symbol is used in combination with embodiments C″ and F″ to indicate their slightly higher tone.

Any past, present, or future musical sound tone can be represented with a symbol, shape, bird head, animal head, human head, picture, word, syllable, or letter by using the Morris Powley tone note scale. Typical embodiments 1a, 1b, 2a, 2b, 3a and 5a, 3b and 5b, 4a, 4b, 6a, 6b, 8a, 8b, 9a, 9b, 10a, 10b, 11a, 11b, 12a, and 12b of the Morris Powley tone note musical scale are used for notation, for playing surfaces of instruments, for singing, and for dancing. Circles within an embodiment are an identification of duration of a tone note. A circle within and no stem indicates a whole note. A circle within and a stem indicates a half note. These embodiments are designated 1b, 2b, 3b, 4b, 5b, 6b, 8b, 9b, 10b, 11b, and 12b and are illustrated in FlG. 13. A morris Powley tone note character with a stem, no flag, and no circle or mouth indicates a quarter note. 13/27

As regards other embodiments, if Morris Powley tone notes are superimposed onto a black background, then black outlines, black flags, and black stems would become a lighter color, tone color, or white in order to be seen. Colors may combine with black or white or note body color for reasons of variety, quality of paper, brightness of ink or paper, contrast, and composition.

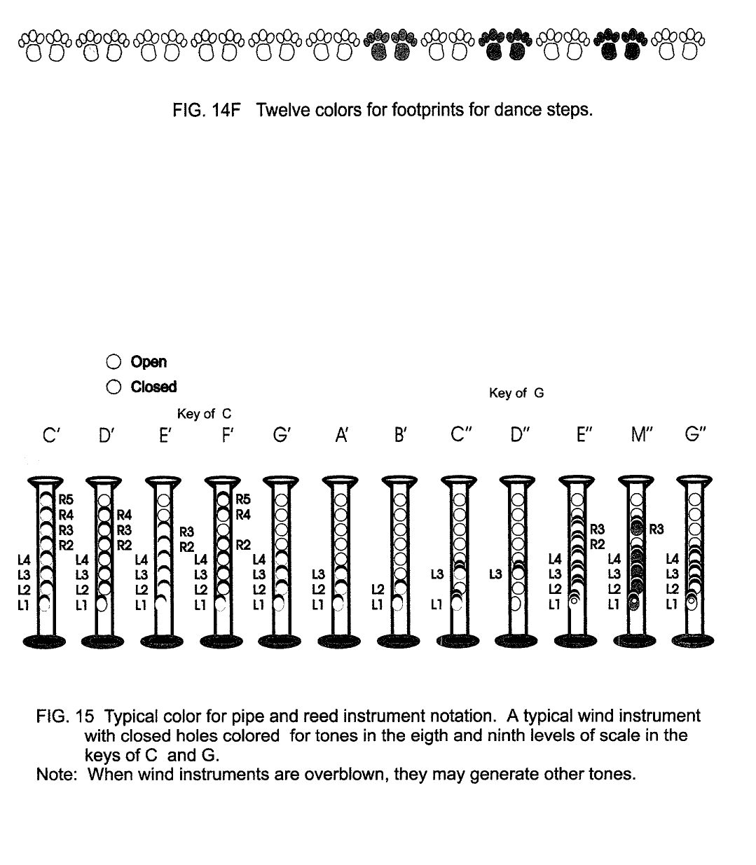

Typical color for pipe and reed instrument notation and fingering is illustrated in FIG. 15 by a typical wind instrument with closed holes colored for tones in eighth and ninth scale levels in the keys of C and G. Note: When wind instruments are overblown, they may generate other tones. 15/27

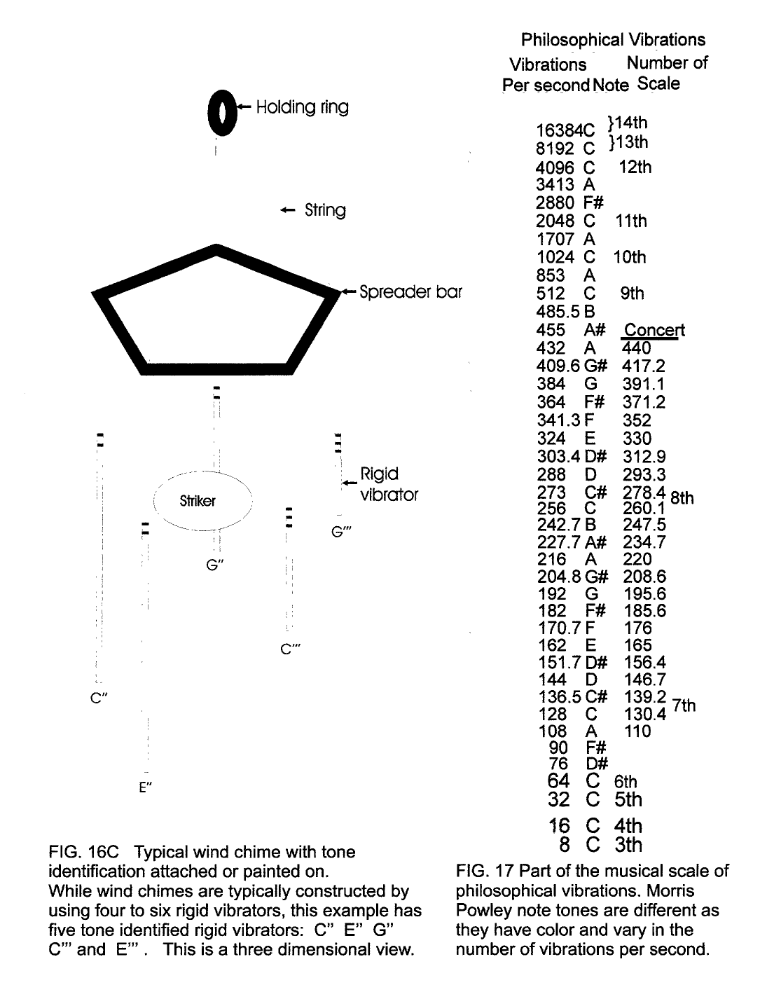

Scale names of a philosophical scale with number of vibrations per second and their close relationship to Morris Powley tone note method is illustrated in FIG. 17. However Morris Powley tone notes do not have a set number of vibrations per second, but rather will vary slightly depending on temperature, tuning of an instrument, composer, and conductor. As instruments warm up, they change tune. The conductor of an orchestra may decide on the exact number of vibrations and its tone name. 17/27

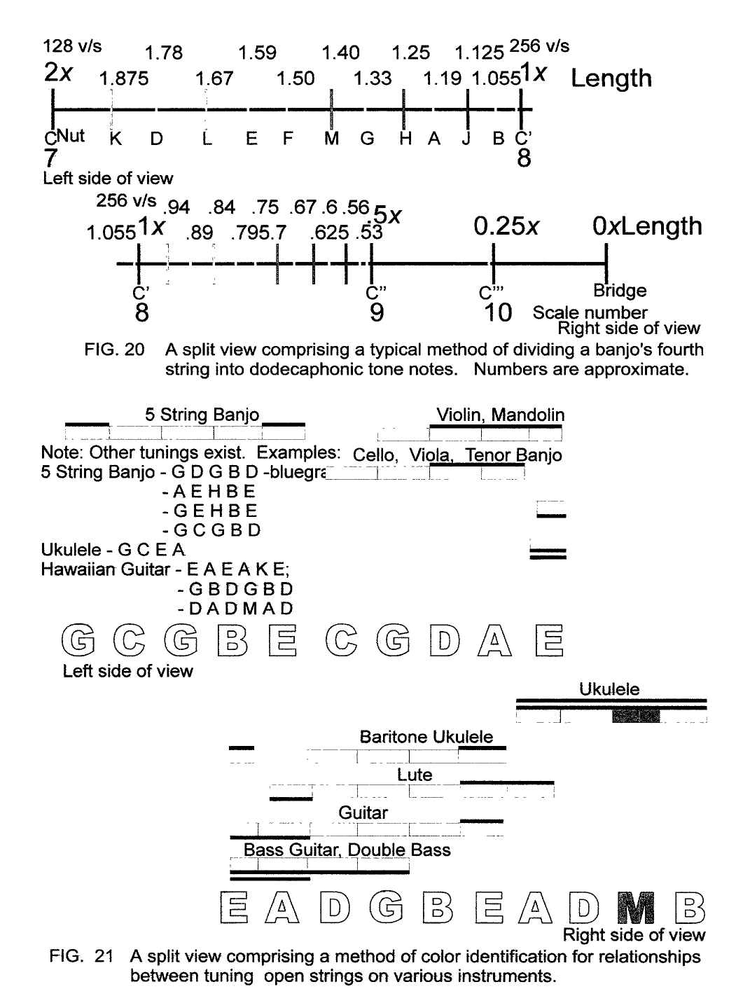

A split view comprising a typical method of dividing a string into dodecaphonic tones is illustrated in FIG. 20 by the example of the fourth string of a tenor banjo. 20/27

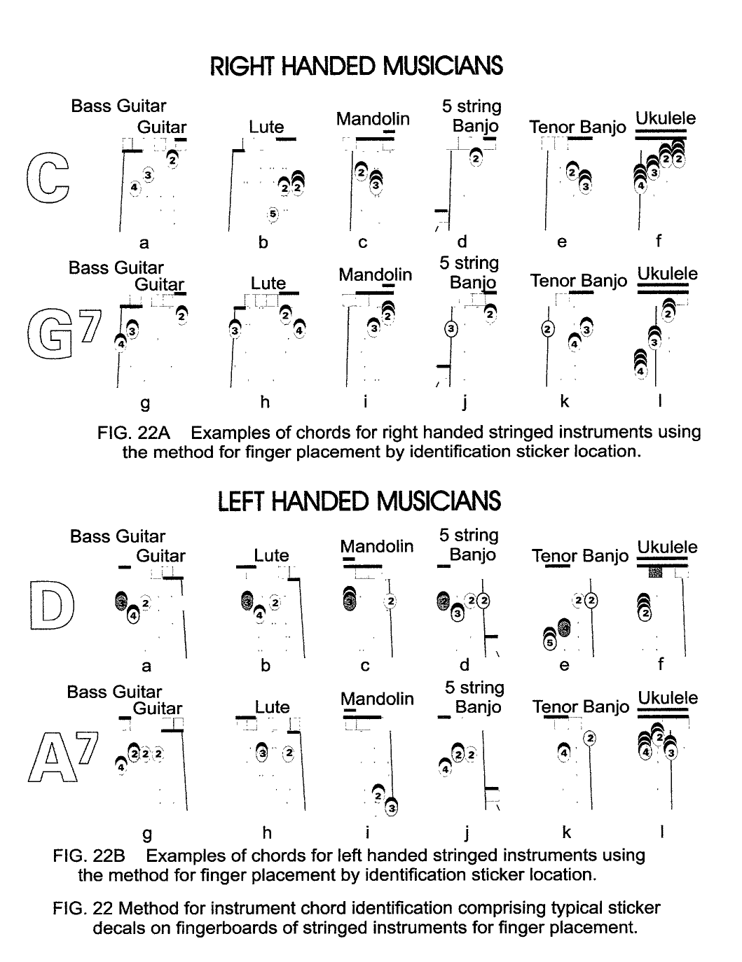

FIG. 21 A split view illustrating, by means of Morris Powley tone note identification, a method of color identification for relationships between tuning open strings on various instruments including the following: violin, mandolin, ukulele, baritone ukulele, lute, five string banjo, cello, viola, tenor banjo, guitar, bass guitar, and double bass. 20/27

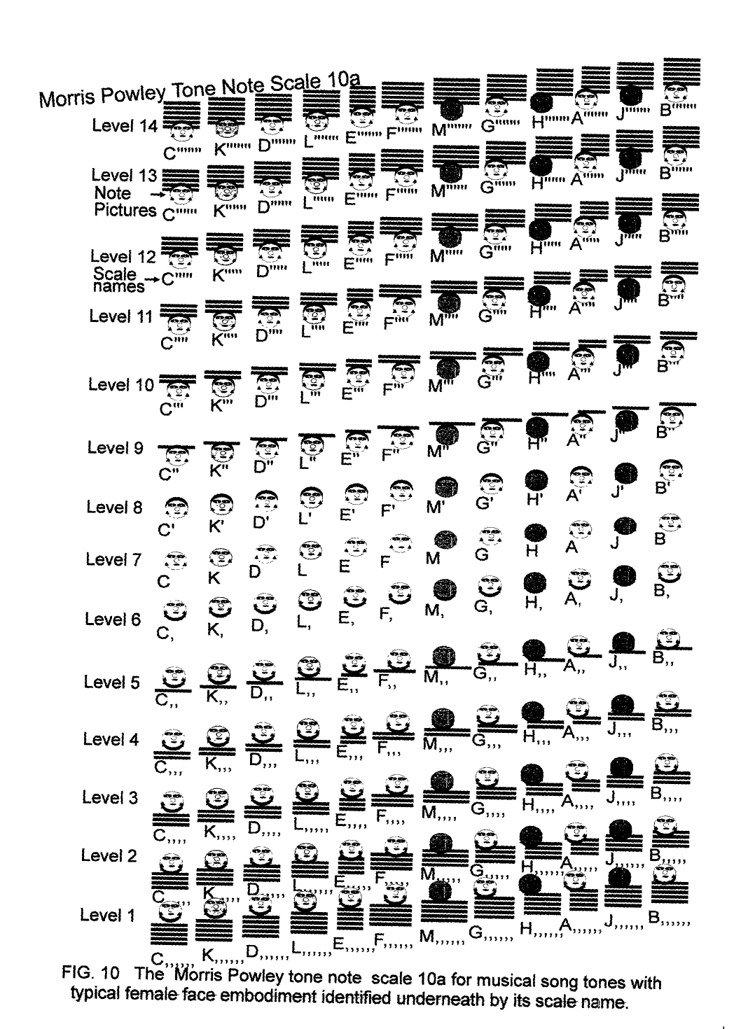

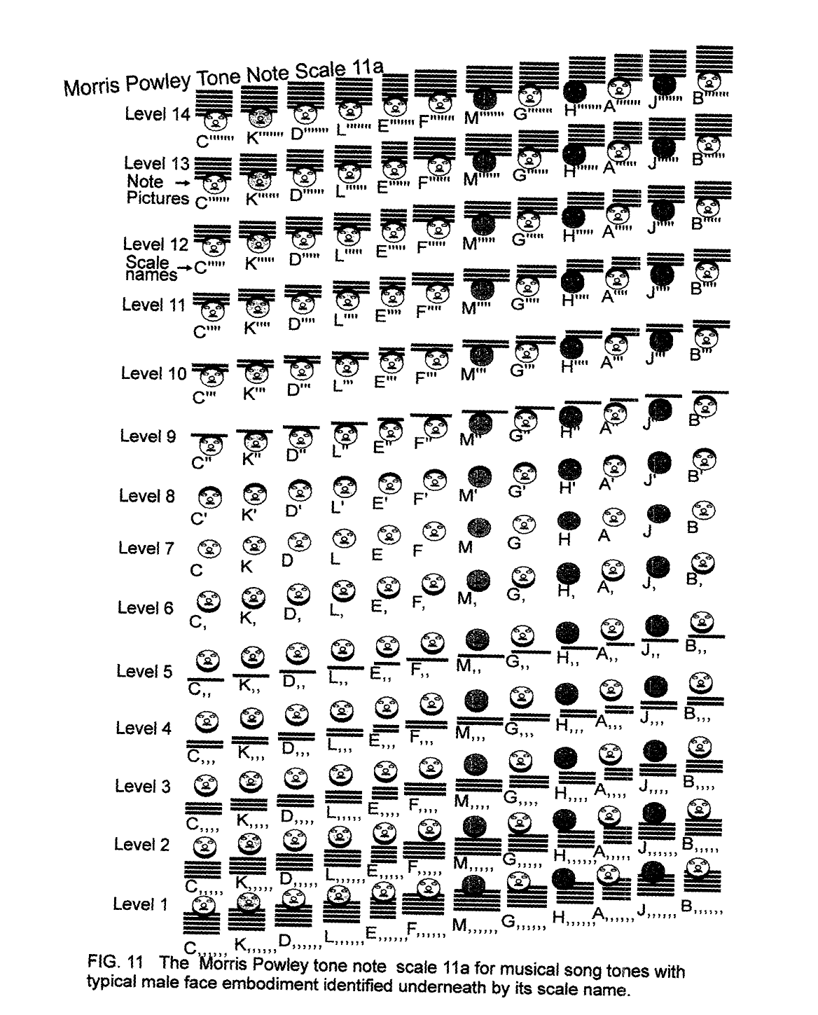

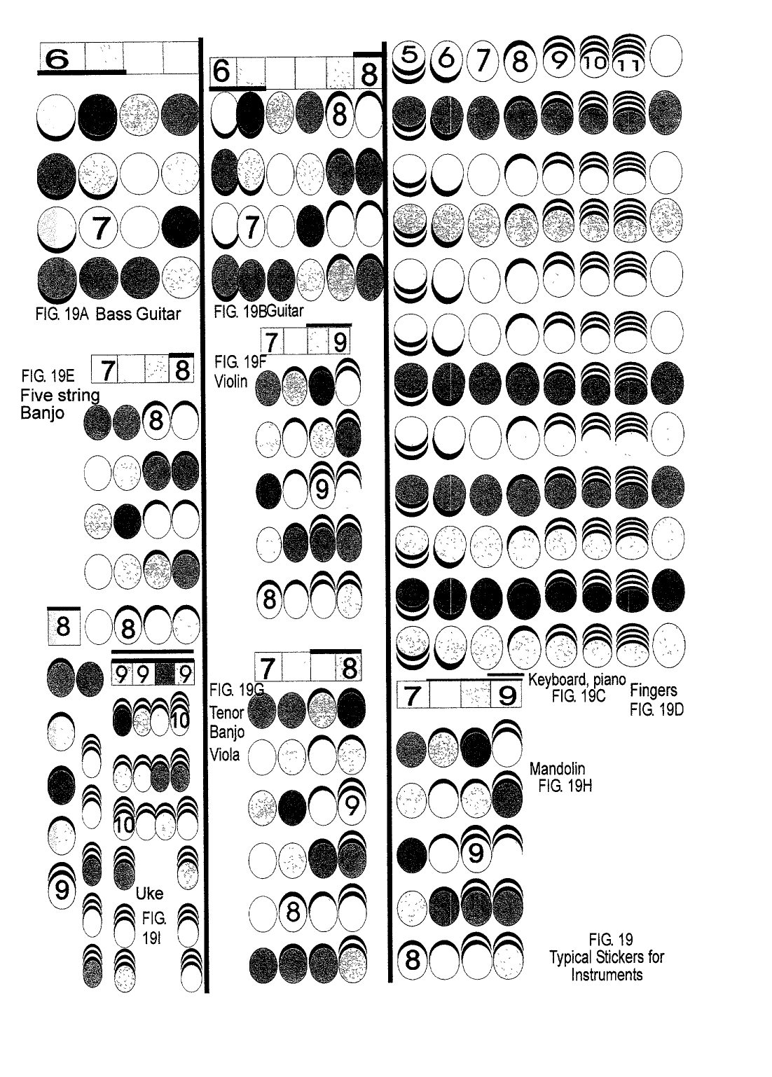

The method of designing typical stickers for instrument playing surfaces is illustrated in FIG. 19. 1927 FIG. 19A is for bass guitar; FIG. 19B is for guitar; FIG. 19C is for keyboard or piano; FIG. 19D is for fingers; FIG. 19E is for five string banjo; FIG. 19F is for violin; FIG. 19G is for tenor banjo or viola; FIG. 19H is for mandolin; and FIG. 19I is for ukulele. Identification tone notes may be temporarily or permanently attached or integrated into musical instruments by means of stickers for Morris Powley tone notes. They may be attached to right and left handed musical instruments including guitar, bass guitar, lute, mandolin, five string banjo, tenor banjo, and ukulele, and banjo as shown in FIG. 14, violin as shown in FIG. 11 and cello and viola as shown in FIG. 10c and may be attached to fingers as shown in FIG. 10b.

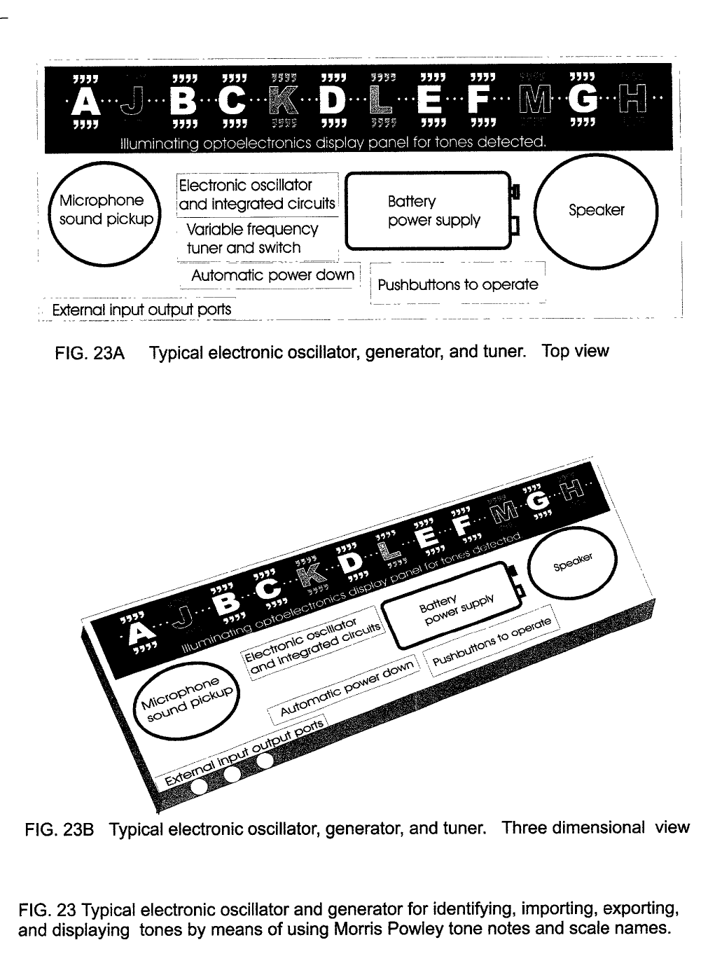

The music tone identification method comprises the use of stickers or coatings on instrument fingerboard to to identify a tone. FIG. 22 illustrates a typical method for instrument tone identification comprising typical identification stickers of Morris Powley tone notes on fingerboards of stringed instruments. It illustrates how to place fingers and unique identification stickers on playing surfaces of right and left handed stringed instruments: 21/27 FIG. 22A has typical examples of chord illustrations for right handed stringed instruments in the keys of C or G7 by the following instruments: bass guitar, guitar, lute, mandolin, five string banjo, tenor banjo, and ukulele. FIG. 22B has typical examples of chord illustrations for left handed stringed instruments in the keys of D and A7 by the following instruments: bass guitar, guitar, lute, mandolin, five string banjo, tenor banjo, and ukulele. Identifying tone note stickers may be placed on fingers of both hands for playing the keyboard or piano as shown in FIG. 27.

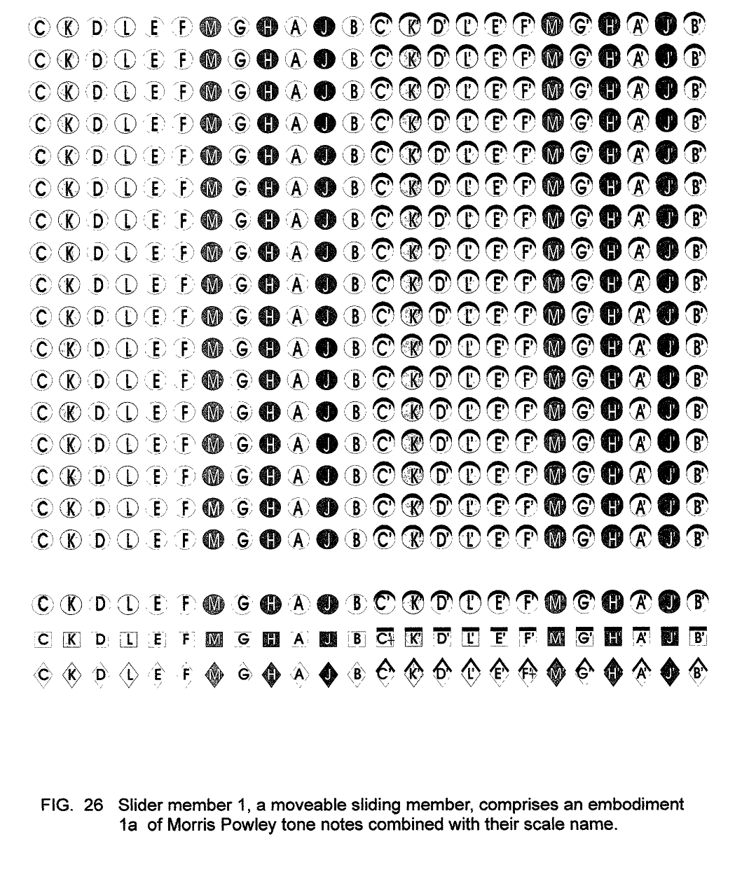

The slider is used for music composition and learning music scales. Slider member 2 in FIG. 25 when printed on transparency film, forms viewing ports for keys of various scales including the following: Major, minor, Pentatonic Major, Pentatonic minor, Blues, Jazz minor, Harmonic minor, Diminished, Locrian, Phrygian, Dorian, Hungarian Gypsy, Mixolydian, Lydian, Skip a tone, Scottish Highland bagpipe, and Invent your own musical scale. 25/27 Slider member 1 in FIG. 26, the moveable inside sliding member, comprises an embodiment 1a of Morris Powley tone notes combined with their scale name. 26/27 By sliding member 1, the composer can determine or invent the scale and the key of the scale.

FIG. 27 illustrates a typical method for musical training using Morris Powley tone notes. The illustrations comprise typical structure of the new notation method with some embodiments intermingled with older methods. The example song is “Shave and a Haircut” in key of C. Typical identifying stickers are on some right and left handed stringed instruments. The dark color of the note stem and larger size indicates a strong accent on note C′ first and note C′ second and a medium accent on A. The claimed vocal singing notation is combined with present popular notation. Embodiment 1a is used for violin. Embodiment 2a is used for mandolin. Embodiment 3a is used for banjo. Embodiment 4a is used for guitar. Beneath each note is the corresponding scale name, tonic solfa name, alphabetic note name, and song word. Musical notes in the key of C comprise a dark background and good composition. Color illustrates good composition by the last note of the song being the same color as the colored bar at the beginning of the song. A tuned wind chime trains the ear for the tones in the song “Shave and a Haircut” in the key of C′. Also shown are typical Morris tone notes with embodiments 1b and 1a.

Computer software graphics programs do comprise Morris Powley tone note scales with embodiments one to twelve for musical character notation identification and are used in FIGS. 1 to 27.

Morris Powley tone notes may use a flag, hole in the center, stem, rest, or half duration dot to comprise duration to present popular notation, or they may use space intervals between embodiments for duration.

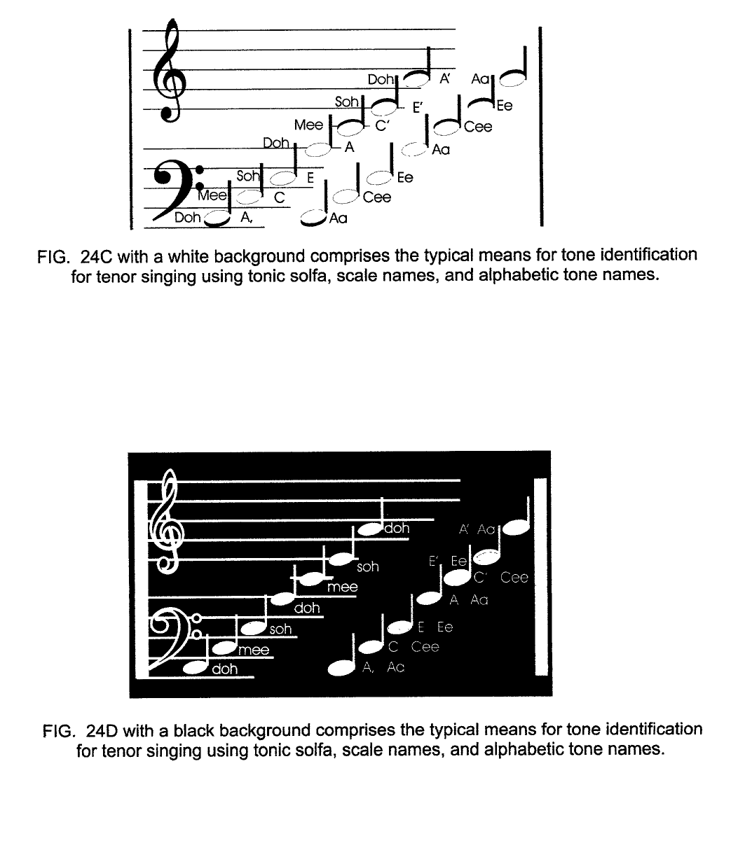

FIG. 24 is a typical identification method for vocal names of singing. FIG. 24A is an illustration comprising the typical means of tone identification for mezzosoprano singing, using scale names, tonic solfa, and alphabetic note names. FIG. 24B is an illustration comprising the means of tone identification for female and male alto singing. FIG. 14C is an illustration with white background comprising the means of tone identification for tenor singing. FIG. 14D is an illustration with black background comprising the means of tone identification for tenor singing.

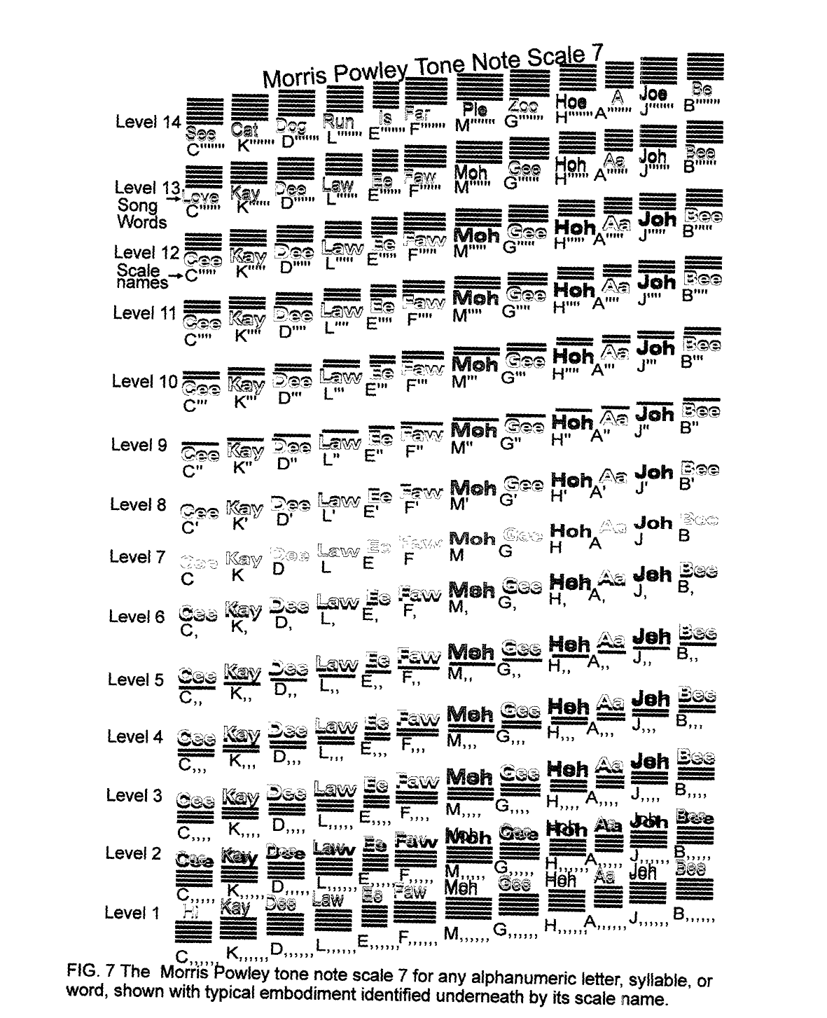

An identified song word, syllable, or letter tone is comprised of a color or combination of colors as typically shown in FIG. 7, it's duration is shown by the degree of space interval between centers of words; and its accent or stress by word size or color contrast. FIG. 14 illustrates the method of singing of alphanumeric letters, syllables, and words by means of corresponding to the Morris Powley tone note scale. FIG. 14A has twelve distinct colors for dodecaphonic tone notes with their associated note names C, K, D, L, E, F, M, G, H, A, J, and B. FIG. 14B has twelve distinct colors for typical song words. Examples shown are; Love, War, Silly, Lap, Ed, Maw, zoo, bud, hoe, ail, Joe, and Be.

FIG. 14D illustrates the method of using typical song words with a black background, accent size, and duration space intervals, with light orange colored bars at the beginning and end of the song to indicate the key of C. This is a typical method comprising colored and shaded song words, syllables, or letters.

FIG. 14E illustrates the method of using typical song words with a white background, accent size, and duration space intervals, with taupe or light brown colored bars at the beginning and end of the song to indicate the key of A. This is a typical method comprising colored and shaded song words, syllables, or letters.

Twelve alphabetic songster tone names with the vocal names Cee, Kay, Dee, Law, Ee, Faw, Moh, Gee, Hoh, Aa, Joh, and Bee comprise the means of vocalizing the twelve note names C, K, D, L, E, F,M,G,H,A,J,and B. There are twelve distinct colors for the twelve alphabetic tone names as shown in FIG. 14C.

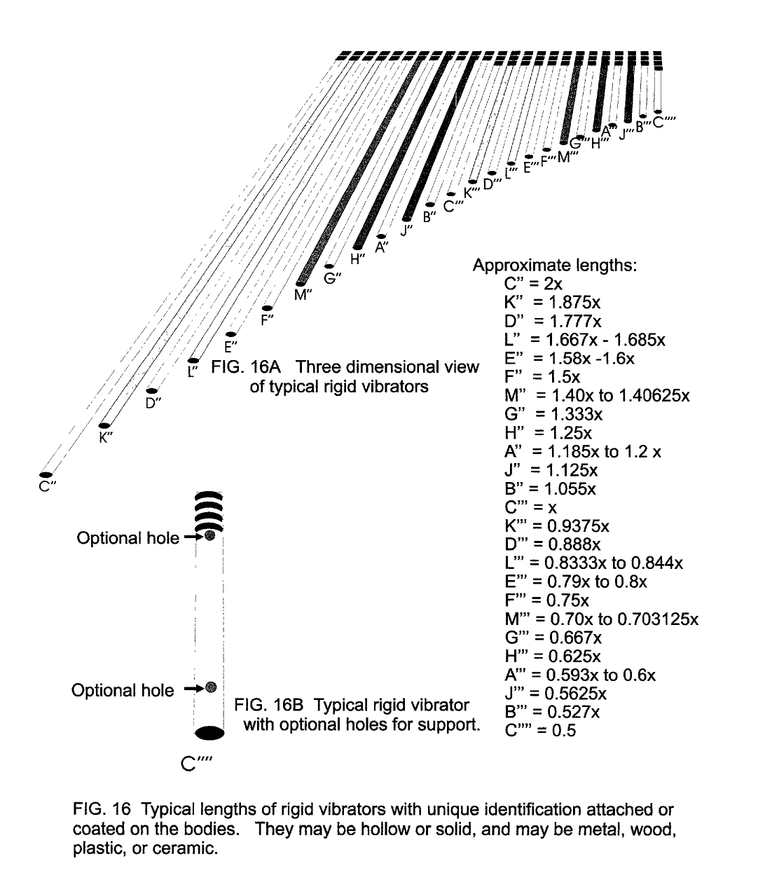

The method of identification of a unique tone of a rigid vibrator by sight and sound is by means of the Morris Powley tone note scale. FIG. 16 shows typical lengths of rigid vibrators with unique identification attached or coated on the bodies. They may be hollow or solid, and may be metal, wood, plastic, or ceramic.

Uniquely identified rigid vibrators are used for voice training to sing in tine. Tuned wind chimes that have unique identification for their tones produce specific tones as an aid to mental memory for tone recognition. See FIG. 16A, FIG. 16B, and FIG. 16C for examples of uniquely identified rigid vibrators. FIG. 16A is a three dimensional view of typical rigid vibrators for the ninth and tenth levels of the dodecaphonic or twelve tones scale. FIG. 16B is a typical rigid vibrator with optional holes for support. One or two holes may be comprised. FIG. 16C illustrates a typical wind chime with tone identification attached or coated on. While wind chimes are typically constructed by using four to six rigid vibrators, this illustration has five uniquely identified rigid vibrators, C″,E″, G″, C′″, and E′″.

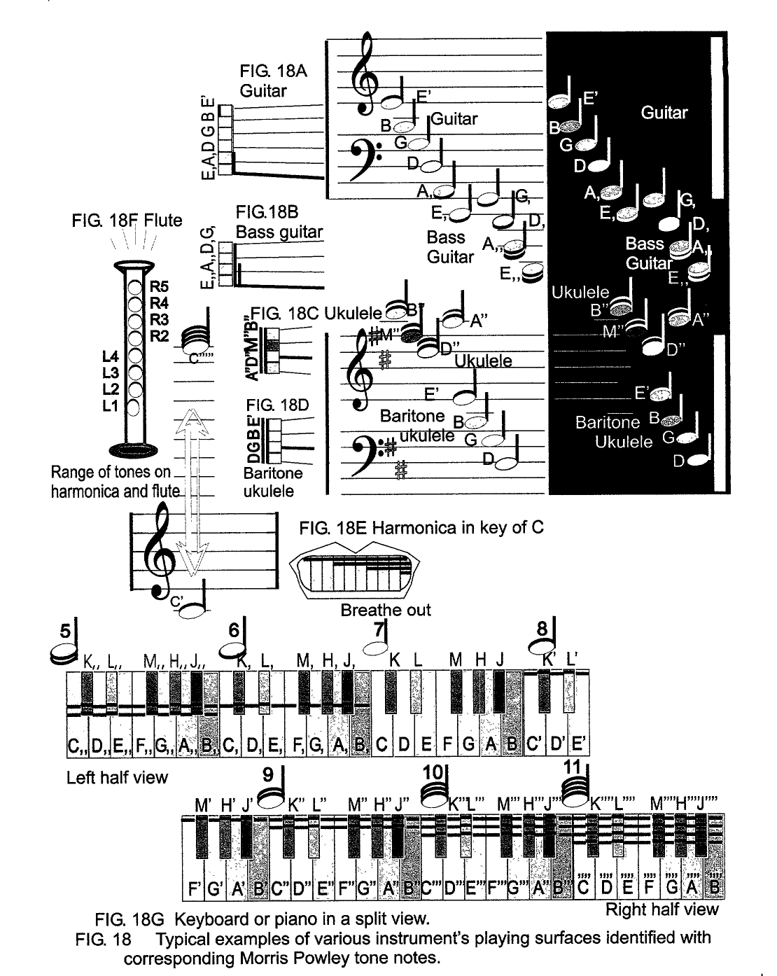

FIG. 18 is a typical example of instruments illustrating the method of their playing surface being identified by means of corresponding Morris Powley tone notes on the following instruments: guitar, bass guitar, ukulele, baritone ukulele, ten hole harmonica in the key of C, breathing out, flute, keyboard or piano in a split view.

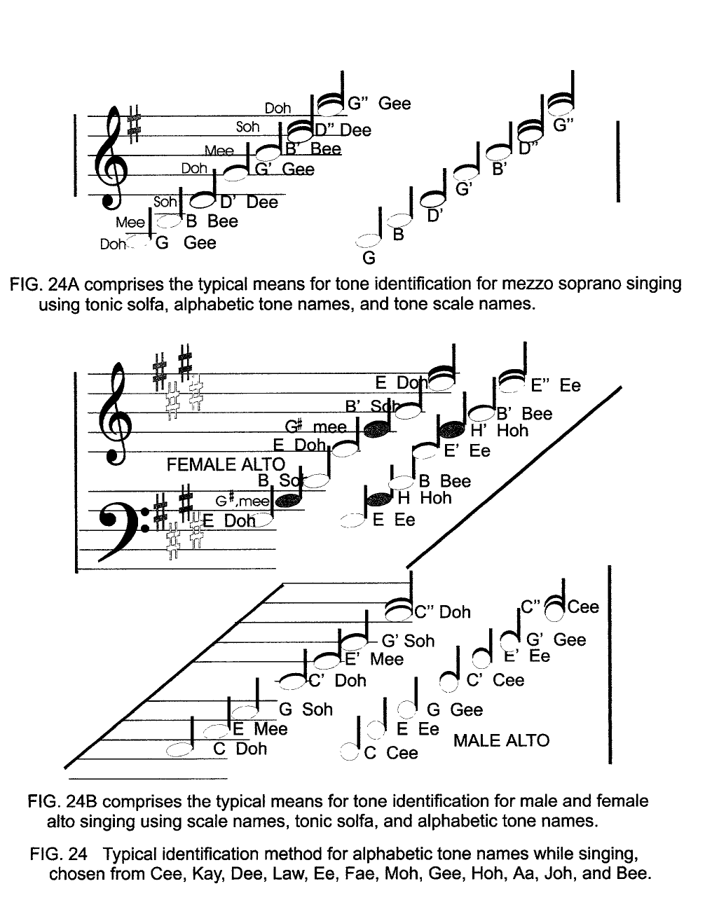

The method that electronic oscillators, generators, and tuners display identified tones in a simple manner at a reasonable economic price to the general public is by means of the Morris Powley tone note scale. FIG. 23 illustrates a typical electronic oscillator, generator, and tuner for identifying, importing, exporting and displaying tones by means of using the Morris Powley tone note identification method.

A typical top view of component layout in FIG. 23a is a microphone sound pickup, speaker, electronic oscillator and integrated circuits, variable frequency tuner and switch, battery power supply, automatic power down circuit, pushbuttons for operation, external input output ports, and illuminating opto electronic display panel to show colored scale notes. Morris Powley tone note identification by means of a light display panel connected to an electronic oscillator and computer is used for quick tuning, tone recognition, and composition. This display is typically illustrated in FIGS. 22A and 22B.

An color light display with corresponding colors to Morris Powley tone notes may also be attached directly to a computer or a musical instrument.

Colored footprints are used for dancing. The color of footprints correspond to tone notes of a song for dance steps, and position of footprints illustrate position of feet. FIG. 27 illustrates typical colored footprints comprising dance steps. The teaching method of using colored footprints for dance steps that correspond with tones is by means of the Morris Powley tone note scale in FIGS. 1 to 12, footprints in FIG. 14F, and typical example in FIG. 27.

Accordingly, the reader will see that colorful, shaped music notes can be used by even the very young to quickly learn how to read, sing, play, and compose music. Colorful music promotes the growth and myelization of brain axons in three and four year old children increasing their spatial temporal reasoning. It permits old fiddlers who can't read music to learn. It allows many left handed persons to seize the opportunity to play a stringed instrument It opens a new world for many people and provides happiness.

There are various possibilities with regard to using this new invention in combination with electronic music. New microtonal scales will be invented. Music instruction will change. It is hoped that Morris Powley tone note identification, teaching, playing, dancing, and notation will enable inventive and adventurous musicians to stir the chemistry in animal, vegetable, mineral, and man.

Although the description above contains many specificities, these should not be construed as limiting the scope of the invention but as merely providing illustrations of some of the preferred embodiments of this invention. Thus the scope of the invention should be determined by the claims and their legal equivalents, rather than by the examples given.

Having described the invention above, various modifications of the techniques, procedures, material, and equipment will be apparent to those in the art. It is intended that all such variations within the scope and spirit of the appended claims be embraced thereby. Modifications and variations may be made to the embodiments without departing from the spirit or scope of the invention as defined in the attached claims.

What I claim as my invention is the following:

1. A tone identification method comprising:
twelve embodiments for one hundred and sixty eight tone notes within a musical scale; wherein each scale comprises fourteen scale levels; wherein each scale level consists of twelve ascending tone notes of distinct colors; whereby each subsequent higher said tone of a distinct color within a scale level doubles its vibrations per second over the preceding lower scale level tone note of the same color, and whereby
the said tone note scale can have an embodiment for each tone note, including the following: ellipse embodiment 1a, ellipse containing a circle embodiment 1b, circle embodiment 2a, circle containing a circle embodiment 2b, rectangular extrovert embodiment 3a, rectangular extrovert containing a circle embodiment 3b, triangle embodiment 4a, triangle containing a circle embodiment 4b, rectangular introvert embodiment 5a, rectangular introvert containing a circle embodiment 5b, diamond embodiment 6a, diamond containing a circle embodiment 6b, alphanumeric letter, syllable, or word embodiment 7, bird head embodiment 8a, bird head containing an open mouth diamond embodiment 8b, female human head embodiment 10a, female human head containing an open mouth oval embodiment 10b, male human head embodiment 11a, male human head containing a open mouth oval embodiment 11b, animal head embodiments 9a and 12a, animal head containing an open mouth embodiments 9b and 12b, to be used at the discretion of the music composer for musical instruments or vocal persons; and whereby
the said tone note embodiment, comprises a plurality of character lines placed above or below its body to identify its scale level; and
a bar corresponding in color to one of said twelve tone notes located at the beginning and end of a song to indicate the key of the song; and
a unique colored sticker or coating on a musical instrument playing surface identifies its corresponding unique tone and said note body; and
accent or stress of a song indicated by size of note body or color contrast of stem, and
a slider with transparent ports to view and compose scales comprised of said tone note bodies; and
a notation system for pipe and reed comprising said tone note bodies indicating holes closed for fingering or playing a note; and
five alphabetical note names in each level of scale to accompany the present seven A, B, C, D, E, F, and G, whereby the five letters H, J, K, L, and M replace all sharps and flats and identify unique tones or pitches; and
chord fingering illustrations using said tone identifying method; the said tone note scale can have an embodiment for each tone note, including the following: alphanumeric song word, syllable, or letter, to be used at the discretion of the music composer for musical instruments or vocal persons; and whereby.

2. Twelve alphabetic songster note names comprised of the vocal names Cee, Kay, Dee, Law, Ee, Faw, Moh, Gee, Hoh, Aa, Joh, and Bee to vocalize the twelve note names C, K, D, L, E, F,M,G,H,A,J,and B in claim 1.

3. A tuned rigid vibrator with its tone identified by said unique identification method of claim 1 by using a colored sticker or coating.

4. A musical instrument with its corresponding playing surface tone position identified by said unique identification method of claim 1 by using a colored sticker or coating.

5. An electronic oscillator, generator, and tuner comprising:
a sticker, coating, computer, and opto electronics display of music tones received and generated corresponding to claim 1 including integrated circuits for indicating relative tone received to that desired; and
an electrical power supply typically including a battery; and
a means to receive a tone, such as a microphone or magnetic pickup; and a means to send an audible tone, such as a speaker.

6. A process of operating a computer software graphics program comprising musical character notation of said identified tone notes of claim 1.

7. Colored footprints illustrating said identified tone notes of claim 1 for dance steps.
